(19) United States
(12) Patent Application Publication
(10) Pub. No.: US 2019/0031176 A1
(43) Pub. Date: Jan. 31, 2019

(54) HYBRID VEHICLE AND METHOD OF CONTROLLING DRIVING MODE THEREOF

(71) Applicants: HYUNDAI MOTOR COMPANY, Seoul (KR); KIA MOTORS CORPORATION, Seoul (KR)

(72) Inventors: Jee Wook HUH, Gwangmyeong-si (KR); Sung Deok KIM, Seongnam-si (KR); Chun Hyuk LEE, Suwon-si (KR)

(21) Appl. No.: 15/847,510

(22) Filed: Dec. 19, 2017

(30) Foreign Application Priority Data
Jul. 31, 2017 (KR) 10-2017-0096918

(51) Int. Cl. B60W 20/13; B60W 30/192

(52) U.S. Cl. CPC B60W 20/13; B60L 11/1809; Y10S 903/903; B60W 30/192

(57) ABSTRACT

A method of controlling a mode change in a hybrid vehicle includes: determining whether or not a first state-of-charge (SOC) condition is satisfied when a current driving mode is a first mode in which discharging is performed; determining whether or not a plurality of additional conditions is satisfied when a result of the determining is that the first SOC condition is satisfied; and performing transition to a second mode in which a state of charge is maintained when one of the additional conditions is satisfied. The additional conditions include at least one of a requested torque or requested power condition, an engine starting need condition, and a second SOC condition.

### CROSS-REFERENCE TO RELATED APPLICATION

This application claims the benefit of priority to Korean Patent Application No. 10-2017-0096918, filed on Jul. 31, 2017, which is hereby incorporated by reference as if fully set forth herein.

### TECHNICAL FIELD

The present disclosure relates to a hybrid vehicle and a method of controlling a driving mode thereof, and more particularly to a hybrid vehicle, which is capable of performing a driving-mode change depending on a change in the state of charge of a battery in consideration of an inefficient engine starting situation, and a control method thereof.

### BACKGROUND

In general, a hybrid electric vehicle (HEV) is a vehicle that uses two types of power sources together, and the two types of power sources are typically an engine and an electric motor. Such a hybrid vehicle has excellent fuel efficiency and power performance and is advantageous in that the amount of exhaust gas is reduced, compared to a vehicle having only an internal combustion engine, and thus has been actively developed in recent years.

The hybrid vehicle may be operated in two driving modes depending on the types of power trains that are driven. One of the modes is an electric-vehicle (EV) mode in which the hybrid vehicle is driven using only an electric motor and the other mode is a hybrid-electric-vehicle (HEV) mode in which the hybrid vehicle obtains power by operating both an electric motor and an engine. The hybrid vehicle changes between the two modes depending on conditions during driving.

In addition to the classification of a driving mode depending on the type of a power rain described above, in particular, in the case of a plug-in hybrid electric vehicle (PHEV), a driving mode may be classified into a charge-depleting (CD) mode and a charge-sustaining (CS) mode based on a change in a battery state-of-charge (SOC). In general, the PHEV is driven by operating an electric motor using battery power without engine power in a CD mode, and uses engine power to prevent a further reduction in the battery SOC in a CS mode.

A general PHEV is driven in a CD mode, regardless of a driving condition, such as driving load, whether or not a battery requires charging, or a distance to a destination, and then performs a change from the CD mode to a CS mode due to the depletion of an SOC. This will be described with reference to FIG. 1.

FIG. 1 illustrates an example of the case in which a general plug-in hybrid electric vehicle (PHEV) performs a mode change.

In FIG. 1, the horizontal axis indicates the distance, and the vertical axis indicates the battery state-of-charge (SOC) of the PHEV.

Referring to FIG. 1, the general PHEV is driven in a CD mode at the onset and then performs a change from the CD mode to a CS mode when the SOC is lowered below a preset reference.

When the PHEV starts driving in a CD mode, the vehicle is driven without starting an engine until the CD mode is changed CS mode. Therefore, the engine remains in a cooled state at the point in time at which the CD mode is changed to the CS mode. Thus, it may be difficult satisfy exhaust gas regulations due to a low catalyst temperature in an engine catalytic converter when the power of the engine is immediately used. In conclusion, the vehicle uses the engine after performing catalyst heating, i.e. engine warmup control, by which the catalytic converter is raised to a normal operating temperature, in order to satisfy the regulations. This will be described below with reference to FIG. 2.

FIG. 2 illustrates an example of the ca se in which general plug-in hybrid electric vehicle (PHEV) performs engine warmup upon a mode change. Referring to FIG. 2, the PHEV, which performs a mode change based on an SOC, performs warmup control once at the time of a change from a CD mode to CS mode. At this time, a reference value is set to be slightly higher than an SOC, which is a reference for changing from a CD mode to a CS mode, and warmup control is performed when an SOC reaches the corresponding reference value. As such, warmup may be completed before the actual change from the CD mode to the CS mode.

However, since a mode change is performed based on an SOC in a general PHEV, transition to a CS mode may occur even in the situation in which engine starting is inefficient. For example, even ignoring the consumption of fuel for warmup control when transition to a CS mode occurs, since the vehicle uses a high engine power operating point in order to increase engine efficiency, the output of the engine is inefficiently used only for charging while waiting for a signal or when stopped. This will be described below with reference to FIG. 3.

FIG. 3 is view for explaining an example of a low-efficiency section, which may occur due to a general driving-mode change.

Referring to FIG. 3, a driving situation illustrated, in which a vehicle speed is gradually reduced until a vehicle temporarily stops, and is then increased. It can be appreciated that an engine is started depending on an NOC despite deceleration, and thus a low-efficiency section with energy waste occurs due to such engine driving despite deceleration/stopping.

The low-efficiency section occurs because, when charging is performed using engine power, a particularly large amount of energy is wasted due to motor charge/discharge efficiency, battery charge/discharge efficiency, and the like. However, since engine efficiency may also be reduced when engine power is reduced for this reason, transition to a CS mode based on an SOC alone makes it difficult to avoid an inefficient situation.

### SUMMARY OF THE DISCLOSURE

The present disclosure is directed to a hybrid vehicle and a method of controlling a driving mode thereof that substantially obviate one or more problems due to limitations and disadvantages of the related art.

An object of the present disclosures to provide a method of more efficiently controlling a mode change in a hybrid vehicle and a vehicle in which the same is implemented.

More particularly, an object of the present disclosure is provide a method of performing a driving-mode change in consideration of various mode change environments and conditions, and a vehicle in which the same is implemented.

Additional advantages, objects, and features of the disclosure will be set forth in part in the description which follows and in part will become apparent to those having ordinary skill in the art upon examination of the following or may be learned from practice of the disclosure. The objectives and other advantages the disclosure may be realized and attained by the structure particularly pointed out in the written description and claims hereof as well as the appended drawings.

To achieve these objects and other advantages and in accordance with the purpose of the disclosure, as embodied and broadly described herein, a method of controlling a mode change in a hybrid vehicle includes: determining, by a hybrid control unit, whether or not a first state-of-charge (SOC) condition is satisfied when a current driving mode is a mode in which discharging is performed; determining, by the hybrid control unit, whether or not a plurality of additional conditions is satisfied when a result of the determining is that the first SOC condition is satisfied, and performing, by the hybrid control unit, transition to a second mode in which a state of charge is maintained when one of the additional conditions is satisfied. The additional conditions comprise at least one of a requested torque or requested power condition, an engine starting need condition, and a second SOC condition.

In another aspect of the present disclosure, a hybrid vehicle includes a hybrid control unit configured to determine whether or not a first state-of-charge (SOC) condition is satisfied when a current driving mode is a first mode in which discharging is performed, determine whether or not a plurality of additional conditions is satisfied when the first SOC condition is satisfied, and perform transition to a second mode in which a state of charge is maintained when one of the additional conditions is satisfied, and an engine control unit configured to control an engine so as to be started in the second mode depending on a determination of the hybrid control unit.

It is to be understood that both the foregoing general description and the following detailed description of the present disclosure are exemplary and explanatory and are intended to provide further explanation of the present disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 illustrates an example of the case in which a general plug-in hybrid electric vehicle (PHEV) performs a mode change;

FIG. 2 illustrates an example of the case in which a general plug-in hybrid electric vehicle performs engine warmup upon a mode change;

FIG. 3 is a view for explaining an example of a low-efficiency section, which may occur due to a general driving-mode change;

FIG. 4 illustrates an example of the power train structure of a hybrid vehicle to which embodiments of the present disclosure may be applied;

FIG. 5 is a block diagram illustrating an example of the control system of a hybrid vehicle to which embodiments of the present disclosure may be applied;

FIG. 6 is a flowchart illustrating an example of a process of performing mode change control in a hybrid vehicle according to an embodiment of the present disclosure; and

FIG. 7 is a view for explaining the effect of mode change control according to an embodiment of the present disclosure via comparison with FIG. 3.

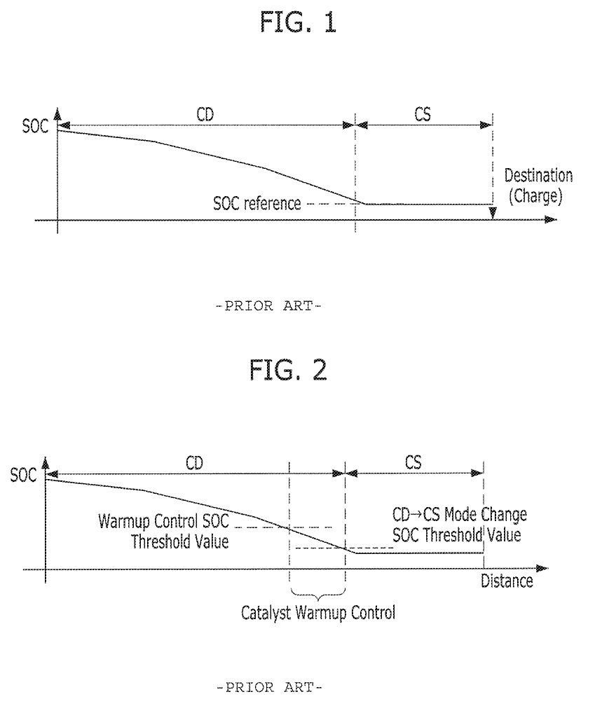

### DETAILED DESCRIPTION OF THE DISCLOSURE

Reference will now be made in more detail to a hybrid vehicle and an efficient transmission control method for the same according to the present disclosure, examples of which are illustrated in the accompanying drawings. With respect to constituent elements used in the following description, suffixes “module” and “unit” are given or mingled with each other only in consideration of ease in the preparation of the specification, and do not have or serve as different meaning.

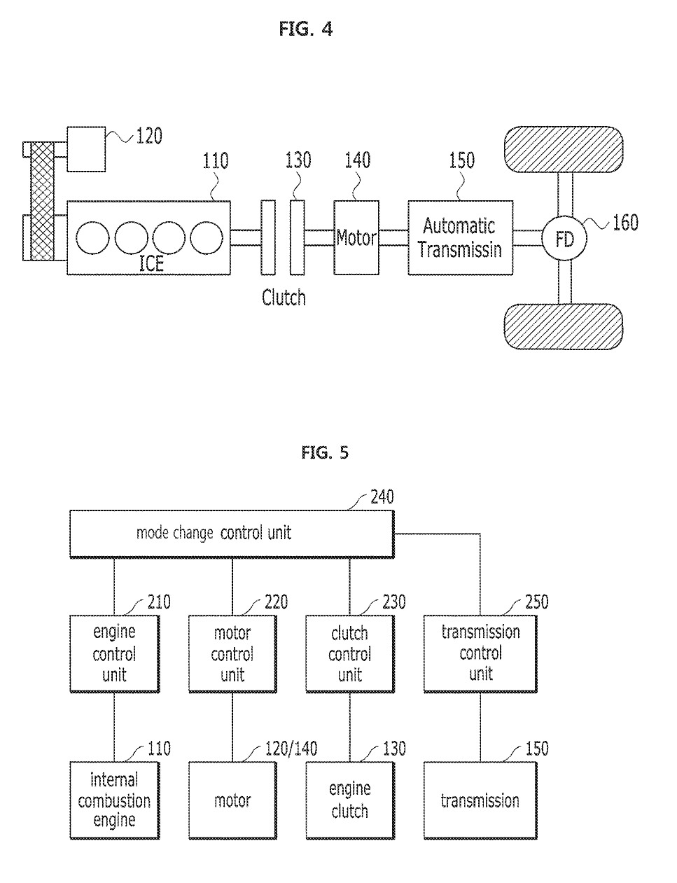

First, the structure of a hybrid vehicle, to which embodiments of the present disclosure may be applied, will be described with reference to FIG. 4.

FIG. 4 illustrates an example of the power train structure of a hybrid vehicle to which embodiments of the present disclosure may be applied.

Referring to FIG, 4, there is illustrated a power train of a hybrid vehicle, which adopts parallel-type hybrid system in which an electric motor (or a driving motor) 140 and an engine clutch 130 are mounted between an internal combustion engine (ICE) 110 and a transmission 150.

In this vehicle, generally, when a driver steps on an accelerator after starting, the motor 140 is first driven using power of a battery in an open state of the engine clutch 130 so that power of the motor 140 moves wheels by way of the transmission 150 and a final drive (FD) 160 (i.e. EV mode). When a greater driving force is gradually required as the vehicle is gradually accelerated, an auxiliary motor (or a starter generator motor) 120 may be operated so as to start the engine 110.

Thereby, when the rotational speeds of the engine 110 and the motor 140 become equal to each other, the engine clutch 130 is finally engaged so that both the engine 110 and the motor 140 drive the vehicle (i.e. transition from an EV mode to an HEV mode). Then, when a predetermined engine-off condition such as, for example, vehicle deceleration, is satisfied, the engine clutch 130 is opened and the engine 110 stops (i.e. transition from an HEV mode to an EV mode). At this time, the vehicle recharges a battery using driving force of wheels via a motor, which is referred to as braking energy regeneration or regenerative braking. Thus, the starter generator motor 120 may function as a starter motor when the engine is turned on, and may function as a generator after the engine is turned on or when rotational energy is recovered during engine off, and thus, the starter generator motor 120 may also be referred to as a hybrid starter generator (HSG).

The relationship between control units in the vehicle in which the above-described power train is applied is illustrated in FIG. 5.

FIG. 5 is a block diagram illustrating an example of the control system of a hybrid vehicle to which embodiments of the present disclosure may be applied.

Referring to FIG. 5, in the hybrid vehicle to which embodiments of the present disclosure may be applied, the internal combustion engine 110 may be controlled by an engine control unit 210, the starter generator motor 120 may be controlled in torque by a motor control unit (MCU) 220, and the engine clutch 130 may be controlled by a clutch control unit 230. Here, the engine control unit 210 is also referred to as an engine management system (EMS). In addition, the transmission 150 is controlled by a transmission control unit. 250.

The respective control units may be connected to a mode change control unit 240 (hereinafter referred to as a “hybrid control unit”), which is a superordinate control unit and performs an overall mode change process, and may provide the mode change control unit 240 with information required for a driving-mode change, engine clutch control upon gear shift, and/or information required for engine off control, or may perform an operation based on a control signal under the control of the mode change control unit 240.

More specifically, the mode change control unit 240 determines whether or not to perform a mode change based on vehicle driving conditions, In one example, the mode change control unit 240 determines a point in the time at which the engine clutch (EC) 130 is opened, and performs hydraulic control (in the case of a wet-type EC) or torque capacity control (in the case of a dry-type EC) when the EC 130 is opened. In addition, the mode change control unit 240 may determine the state of the EC 130 (e.g. lock-up, slip, or open) and may control the point in time at which the engine 110 stops fuel injection. In addition, the mode change control unit 240 may control the torque of the starter generator motor 120 for engine off control, thereby controlling the recovery of engine rotational energy. In addition, the mode change control unit 240 may determine whether or not a CD-CS mode change condition according to the present embodiment, which will be described later, is satisfied, and may perform overall control required for a mode change and control of subordinate control units depending thereon.

It would be obvious to one of ordinary skill in the art that the aforementioned relationship between the con units and functions/divisions of the control units are exemplary and, thus, are not limited to the terms. For example, the mode change control unit 240 may be embodied by allowing any one of other control units except for the mode change control unit 240 to provide a corresponding function, or two or more of other control units may distribute and provide the corresponding function.

In addition, the respective components have been described based on a parallel-type power train in FIGS. 4 and 5, but embodiments of the present disclosure are not limited as to the type thereof, so long as the hybrid power train enables a change between a CD mode and a CS mode.

Hereinafter, a method of controlling a mode change more efficiently according to an embodiment of the present embodiment will be described based on the above-described vehicle structure.

The method of controlling a mode change according to the present embodiment may include a process of determining whether or not additional transition conditions are satisfied when there is need for transition to a mode, and performing transition to a CS mode when any one condition is satisfied, or otherwise delaying transition to a CS mode.

Here, the need for transition to a CS mode may mean the case in which an SOC value (hereinafter, for convenience, referred to as “α”), which is a general CS mode change condition, has been reached. In addition, the additional transition on conditions may include SOCs that are different from “α”, a driver requested torque, need for engine starting, and the like. Hereinafter, the respective conditions will be described in detail.

First, when a driver requested torque (or requested power) is less than a reference torque (or reference power), which is a reference for changing from an EV mode to an HEV mode, transition to a CS mode may be delayed until another CS mode transition condition according to the present embodiment is satisfied.

This serves to prevent engine power from being mainly used in charging, and thus disappearing as charging/discharging loss, or to prevent engine power that exceeds a charging capacity from being simply wasted when the engine is running and the driver requested torque or power is small.

Next, the case in which engine starting is necessary may be a CS mode transition condition according to the present embodiment. For example, the case in which a requested torque/power of a predetermined magnitude or more is generated, the case in which an air conditioner requests engine starting, the case in which there is an engine starting request depending on engine diagnostic logic, and the case in which catalyst warmup is required in order to satisfy regulations may be CS mode transition conditions.

Here, the magnitude of the requested torque/power may be set differently depending on an SOC and driving load (i.e. whether ascending or descending an incline). In addition, room heating may be performed with the temperature of cooling water in the case in which an air conditioner requests engine starting, but is not necessarily limited thereto.

In addition, an SOC may be considered. The SOC, which is a CS mode change condition according to the present embodiment, may be set to a value (hereinafter referred to as “ [symbol] ”) lower than “α” (i.e. the SOC as a general CS mode change condition) This serves to prevent battery over-discharging caused when the situation in which the above-described conditions are not satisfied continues.

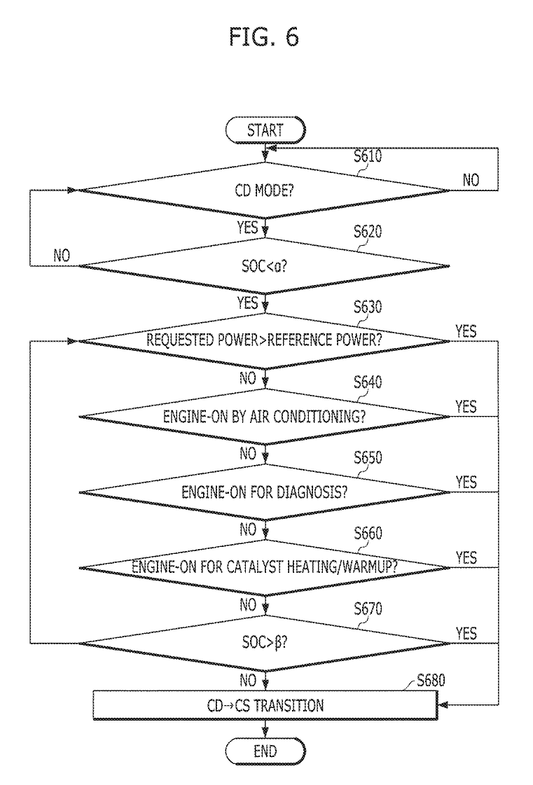

A mode change control process depending on the determination of a CS mode change condition described above is illustrated in the flowchart in FIG. 6.

FIG. 6 is a flowchart illustrating an example of a process of performing mode change control in a hybrid vehicle according to an embodiment of the present disclosure.

Referring to FIG. 6, first, whether or not a current driving mode is a CD mode is determined (S610). When the current driving mode is a CD mode, and when an SOC is less than a preset reference, i.e. “α”, the process proceeds to additional condition determination (S620).

When any one of the case in which a current driver requested power is greater than preset reference power (S630), the case in which there is an engine starting request from an air conditioner (S640), the case in which there is an engine starting request for diagnosis (S650), and the case in which engine starting is required for engine warmup or catalyst heating (S660) is satisfied, transition to a CS mode may be performed (S680). Even if none of the above-described conditions (S630 to S660) are satisfied, transition to a CS mode may be performed when an SGC is less than “ [symbol] ” (S680).

When any one of the above-described conditions 5630 to S670 is not satisfied, a change to a CS mode is delayed (S670→S630).

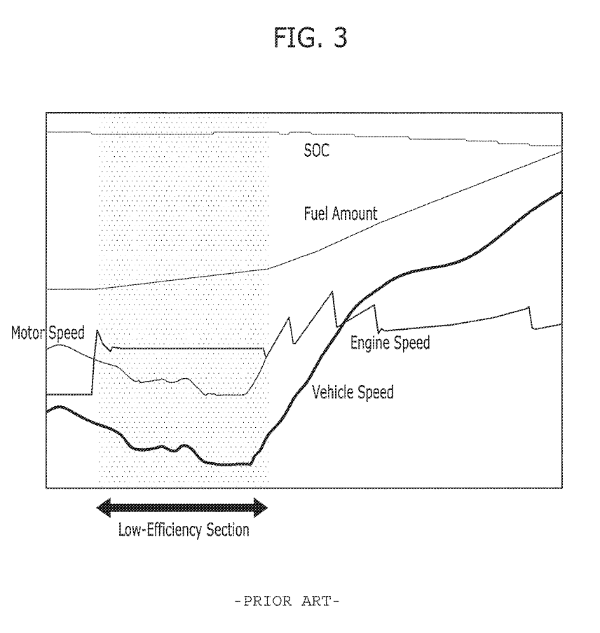

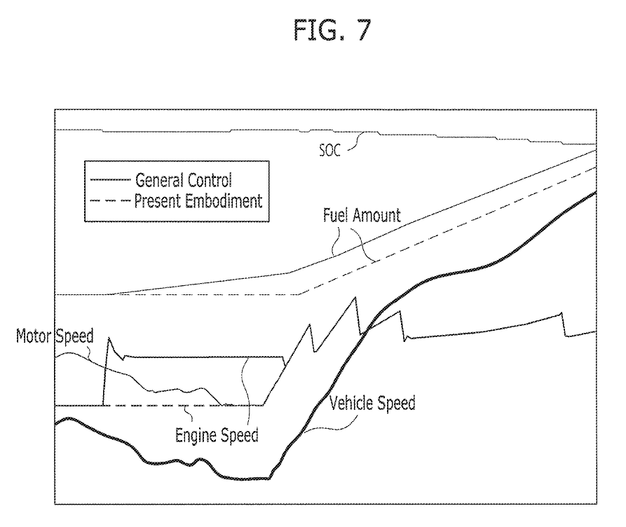

Next, the effect of mode change control according to the present embodiment will be described with reference to FIG. 7 FIG. 7 is a view for explaining the effect of mode change control according to an embodiment of the present disclosure via comparison with FIG. 3.

Referring to FIG. 7, the situation is illustrated, in which a vehicle speed is gradually reduced until a vehicle temporarily stops, and is then increased, similar to that illustrated in FIG. 3. When general mode change control is performed, an engine starts depending on an SOC condition despite deceleration, and thus, a low-efficiency section with energy waste occurs due to such engine driving despite deceleration/stopping. On the other hand, when control according to the present embodiment is performed, engine starting may be delayed until vehicle acceleration is performed after a vehicle stops so long as any other condition is satisfied, such as that a requested torque upon deceleration is less than a reference torque or that an SOC is greater than “ [symbol] ”. Thus, unnecessary fuel loss may be prevented.

The disclosure described above may be implemented as computer readable code in a medium in. which. a program is recorded. Computer readable recording media include all kinds of recording devices in which data readable by computer systems is stored. The computer readable recording media include a Hard Disk Drive (HDD), a Solid State Drive (SSD), a Silicon Disk Drive (SDD), a ROM, a RAM, a CD-ROM, a magnetic tape, a floppy disk, an optical data storage system, etc.

As is apparent from the above description, a hybrid vehicle according to at least one embodiment of the present disclosure having the above-described configuration may more efficiently control a mode change.

In particular, since a mode change is performed in consideration of all of requested power, whether or not an air conditioner is operated, need for diagnosis, whether or not catalyst warmup is performed, and the like, it is possible to prevent engine starting in a low-efficiency situation, which may increase fuel efficiency.

It will be appreciated by persons skilled in the art that that the effects that could be achieved with the present disclosure are not limited to what has been particularly described hereinabove and other advantages of the present disclosure will be more clearly understood from the above detailed description taken in conjunction with the accompanying drawings.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A method of controlling a mode change in a hybrid vehicle, the method comprising:
determining, by a hybrid control unit whether or not a first state-of-charge (SOC) condition is satisfied when a current driving mode is a first mode in which discharging is performed;
determining, by the hybrid control unit, whether or not a plurality of additional conditions is satisfied when the first SOC condition is satisfied; and
performing, by the hybrid control unit, transition to a second mode in which a state of charge is maintained when one of the additional conditions is satisfied,
wherein the additional conditions comprise at least one of a requested torque requested power condition, an engine starting need condition, and a second SOC condition.

2. The method according to claim 1, wherein the first SOC condition is satisfied when a current SOC is less than a first SOC, which is a reference SOC for change to the second mode.

3. The method according to claim 2, wherein the second SOC condition is satisfied when the current SOC is less than a second SOC, and the second SOC is less than the first SOC.

4. The method according to claim 1, wherein the requested torque or requested power condition is satisfied when a current driver requested torque or driver requested power is greater than a reference.

5. The method according to claim 4, wherein the reference is determined depending on a current SOC and current driving load.

6. The method according to claim 1, wherein the engine starting need condition is satisfied when a current condition corresponds to at least one of a case in which there is an engine starting request from an air conditioner, a case in which there is an engine starting request for diagnosis, and a case in which engine warmup or catalyst heating is required.

7. The method according to claim 1, further comprising maintaining the first mode when none of the additional conditions are satisfied.

8. The method according claim 1, wherein the first mode comprises a charge-depleting (CD) mode, and the second mode comprises a charge-sustaining (CS) mode.

9. The method according to claim 1, wherein the hybrid vehicle comprises a plug-in hybrid electric vehicle (PHEV).

10. A non-transitory computer-readable recording medium in which a program for executing the method of controlling a mode change in a hybrid vehicle according to claim 1 is recorded.

11. A hybrid vehicle comprising:
a hybrid control unit configured to determine whether or not a first state-of-charge (SOC) condition is satisfied when a current driving mode is a first mode in which discharging is performed, to determine whether or not a plurality of additional conditions is satisfied when the first SOC condition is satisfied, and to perform transition to a second mode in which a state of charge is maintained when one of the additional conditions is satisfied; and
an engine control unit configured to control an engine start in the second mode depending on a determination of the hybrid control unit.

12. The hybrid vehicle according to claim 11, wherein the first SOC condition is satisfied when a current SOC is less than a first SOC, which is a reference SOC for a change to the second mode.

13. The hybrid vehicle according to claim 12, wherein a second SOC condition is satisfied when the current SOC is less than a second SOC, and the second SOC is less than the first SOC.

14. The hybrid vehicle according to claim 11, wherein a requested torque or requested power condition is satisfied when a current driver requested torque or driver requested power is greater than a reference.

15. The hybrid vehicle according to claim 14, wherein the reference is determined depending on a current SOC and current driving load.

16. The hybrid vehicle according to claim 11, wherein an engine starting need condition is satisfied when a current condition corresponds to at least one of a case in which there is an engine starting request from an air conditioner, a case in which there is an engine starting request for diagnosis, and a case in which engine warmup or catalyst heating is required.

17. The hybrid vehicle according to claim 11, wherein the first mode is maintained when none of the additional conditions are satisfied.

18. The hybrid vehicle according to claim 11, wherein the first mode comprises a charge-depleting (CD) mode, and the second mode comprises a charge-sustaining (CS) mode.

19. The hybrid vehicle according to claim 11, wherein the hybrid vehicle comprises a plug-in hybrid electric vehicle (PHEV).

20. The hybrid vehicle according to claim 11, wherein the additional conditions comprise at least one of a requested torque or requested power condition, an engine starting need condition, and a second SOC condition.
